(19) United States
(12) Patent Application Publication
(10) Pub. No.: US 2026/0002574 A1
(43) Pub. Date: Jan. 1, 2026

(54) SINGLE VALVE SHOCK

(71) Applicant: Fox Factory, Inc., Duluth, GA (US)

(72) Inventors: Connor Randall, Poncha Springs, CO (US); Michael Labbe, Scotts Valley, CA (US); Rick Strickland, Winder, GA (US)

(21) Appl. No.: 18/922,677

(22) Filed: Oct. 22, 2024

Related U.S. Application Data
(60) Provisional application No. 63/666,096, filed on Jun. 28, 2024.

(51) Int. Cl. F16F 9/34; F16F 9/36; F16F 9/48

(52) U.S. Cl. CPC F16F 9/34; F16F 9/369; F16F 9/48; F16F 2226/04; F16F 2230/06

(57) ABSTRACT

A single valve shock system is described. The single valve shock system includes a single base valve, such as a single semi-active base valve provided between at least one zone of an inner body and a reservoir of the shock. The single valve shock system may also include a refill check valve provided between the at least one zone of the inner body and the reservoir, wherein the refill check valve is in communication with the single base valve to provide the bypass flow to the inner body.

### BACKGROUND OF THE INVENTION

### Technical Field

This invention relates generally to a single valve shock and more particularly to a single valve shock that enables the control of compression and rebound damping with one electronic valve.

### State of the Art

There are drawbacks to single valve shocks, primarily around pressure balancing and limited range of movement. For example, some shocks include a shock with a main piston valve and work in a monotube but have drawbacks related to dead length, valve wiring, limited flow (range), pressure balance (risk cavitation) and/or flow control. Other shocks include an external main piston bypass having a reduced dead length. These shocks also have drawbacks including limited flow, pressure in body bypass valves and bleeds, base valve balance (risk cavitation), and/or flow control. Residual out the bottom shocks that can achieve large rebound control range with standard part sets also have drawbacks, such as requiring a large shaft diameter to optimize control range in compression, ensuring enough reflow, and/or if N₂ pressure is high, a large rod reaction force would result.

Accordingly, there is a need for an improved single valve shock that can control pressure and rebound flow.

### SUMMARY OF THE INVENTION

The present invention relates to a single valve shock that enables the control of compression and rebound damping with one electronic valve. One base valve can control pressure and rebound flow.

An embodiment includes a single valve shock system comprising: an inner body having a piston and a piston shaft slideable therein, wherein the inner body is provided with at least one zone; a reservoir in communication with the inner body; a single base valve provided between the reservoir and the at least one zone of the inner body, wherein the single base valve receives bypass flow from the at least one zone; and a refill check valve provided between the at least zone of the inner body and the reservoir, wherein the refill check valve is in communication with the single base valve to provide the bypass flow to the inner body.

The at least one zone may comprise a top out zone, a bottom out zone, and a ride zone. The single base valve may be a single semi-active base valve. The refill check valve may be provided between the bottom out zone of the inner body and the reservoir. At least one bypass shim may be provided along an outer surface of the inner body. The at least one bypass shim may extend over at least one aperture provided in the inner body. A backup plate may be provided over the at least one bypass shim. A body adapter may be provided on an upper end portion of the inner body. The body adapter may be provided with an inner annular flange portion seated on the upper end portion. An O-ring may be provided within an annular channel formed about an inner surface portion of the body adapter.

An outer body may be provided about the inner body to provide an annular channel therebetween. A check valve annular assembly may be provided on the inner body within the annular channel. The check valve annular assembly may be seated against an upper shoulder stop provided on the inner body. A coil spring may bias the check valve annular assembly against the upper shoulder stop. A directional check valve may be provided between the top out zone and the single semi-active base valve in order to accommodate the bypass flow. A main piston compression valve and a main piston rebound valve may be provided between the top out zone and the bottom out zone.

A check valve may be provided between the top out zone and the ride zone. A bleed may be provided in the top out zone and a reflow may be provided between the top out zone and the ride zone. A first check valve and a first bleed may be provided in the top out zone and a second check valve and a second bleed may be provided between the top out zone and the ride zone. A bleed may be provided between the bottom out zone and the reservoir parallel to the refill check valve. A first bleed may be provided in a bottom portion of the top out zone and a second bleed may be provided in a top portion of the bottom out zone. A first reflow may be provided between the top out zone and the ride zone and a second reflow may be provided between the ride zone and the bottom out zone.

Another embodiment includes a method of assembling a single valve shock comprising: providing an inner body having a piston and a piston shaft slideable therein; providing the inner body with a top out zone, a bottom out zone, and a ride zone; providing communication between a reservoir and the inner body; providing a single semi-active base valve between the reservoir and each of the top out zone, the ride zone, and the bottom out zone of the inner body; receiving bypass flow from the top out zone, the ride zone, and the bottom out zone to the single semi-active base valve; providing a refill check valve between the bottom out zone of the inner body and the reservoir; providing communication between the refill check valve and the single semi-active base valve; and providing the bypass flow to the inner body.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a schematic view of a single valve shock in accordance with an embodiment;

FIG. 2 is a schematic view of a single valve shock in accordance with an embodiment;

FIG. 3 is a schematic view of a single valve shock in accordance with an embodiment;

FIG. 4 is a schematic view of a single valve shock in accordance with an embodiment;

FIG. 5 is a schematic view of a single valve shock in accordance with an embodiment;

FIG. 6 is a schematic view of a single valve shock in accordance with an embodiment;

FIG. 7 is a schematic view of a single valve shock in accordance with an embodiment;

FIG. 8 is a partial cross-sectional and schematic view of a single valve shock in accordance with an embodiment;

FIG. 9 is a partial cross-sectional and schematic view of a single valve shock in accordance with an embodiment;

FIG. 10 is a cross-sectional view of a single valve shock in accordance with an embodiment;

FIG. 11 is a cross-sectional view of a single valve shock in accordance with an embodiment;

FIG. 12 is a partial perspective view of a single valve shock in accordance with an embodiment; and

FIG. 13 is a block diagram of steps of a method of assembly of a single valve shock in accordance with an embodiment.

### DETAILED DESCRIPTION OF EMBODIMENTS OF THE INVENTION

As discussed above, embodiments of the present invention relate to a single valve shock that enables the control of compression and rebound damping with a single electronic valve.

The internal bypass of the single valve shock is combined with a bottom out (BO) zone that communicates with a reservoir and the checked reflow from the reservoir. This enables high bottom out (BO)/top out (TO) forces without cavitation. The internal bypass reduces the amount of flow needed through the single valve keeping lower shock pressures in the ride zone and reducing the risk of choking base valves.

The single electronic valve of the present invention enables the semi-active control of compression and rebound damping. Optimizing the ratio of shaft volume displacement vs. annular area tunes the single valve shock system for optimal electronic control. The single electronic valve is located between the inner/outer body of the single valve shock. The single electronic valve is retained by an upper stop on the inner body by high pressure pushing up and retained by an O-ring friction and/or spring force from moving down. This prevents cavitation in the top out (TO) zone and enables additional tuning of high-speed rebound flow, if desired.

The system of the present invention may have a smaller bore within the inner body leaving a larger gap between the inner/outer body of the shock. This can lead to overstressing bypass shims A shim backup plate may be used to stop the bypass shims from being overstressed and limit the deflection of the bypass shims. Yielding of the bypass shims can also be prevented by using the shim backup plate. The shim backup plate can further restrict flow, if desired.

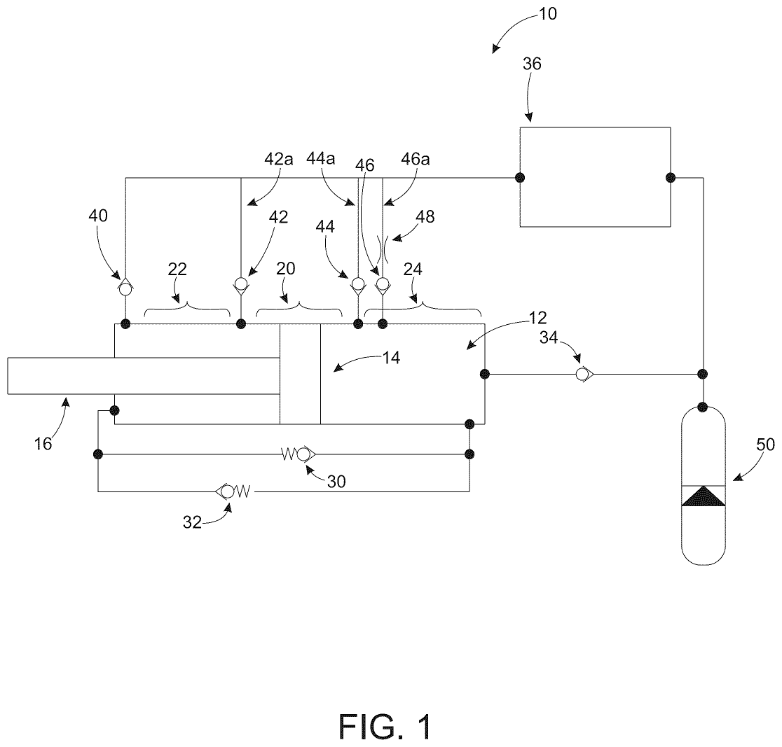

Referring to the drawing figures, FIGS. 1-12 depict embodiments of a single valve shock 10. The single valve shock 10 comprises an inner body 12, a piston 14 and a piston shaft 16. The single valve shock 10 includes three zones-a ride zone 20, a top out (TO) zone 22 and a bottom out (BO) zone 24. The single valve shock 10 further includes a main piston compression valve 30, a main piston rebound valve 32, a refill check valve 34, a single semi-active base valve 36, and a reservoir 50.

Referring to FIG. 1, an embodiment of the single valve shock 10 may comprise a directional check valve 40, and a check valve 42 provided with bypass hole 42a, staggered bypass holes 44a, 46a having respective check valves 44, 46. A restriction or bleed 48 is provided with check valve 46.

The tuning of the embodiment of the single valve shock 10 depicted in FIG. 1 includes the following elements. With regard to the main piston compression valve 30 and the main compression rebound valve 32, the rebound is stiff and tuned for top out (TO) forces desired and the compression is stiff and tuned for the bottom out (BO) forces desired. With regard to the single semi-active base valve 36, the single semi-active base valve 36 is set to about the blowoff pressure of the directional check valve 40. If the blowoff pressure is lower, resolution tends to be lost. If the blowoff pressure is higher, higher forces tend to be achieved at higher speeds which may result in choking the single semi-active base valve 36. In another embodiment, the single semi-active base valve 36 may include a restriction or bleed (not shown) if less noise is desired. The single semi-active base valve 36 may be used to set a soft setting.

The bypass sets TO/BO zones and high-speed ride zone damping. The compression of the single valve shock 10 affects high speed compression damping by beginning to choke off the main piston flow to the single semi-active base valve 36, forcing fluid to go through the main piston. The rebound effect is none if reflow holes are used. Once the reflow holes are reached, a high TO force zone is entered. Tuning is similar to the compression high speed effect by omitting reflow holes and utilizing the directional check valve 40 for high reflow.

The architecture of the single valve shock 10 may consider several factors. For example, if reflows in directional check and refill check are high enough, then the single valve shock 10 does not cavitate and lower N₂ pressures may be run for better seal drag, etc. In general, the ratios of main piston area to annular area about the piston shaft have a large effect on tuning. The ratios may be adjusted if a user wants more range in compression versus rebound. Compression range is dependent on piston shaft volume flow rates. Rebound range in the ride zone is dependent on annular piston area (for example if very stiff stack). Blowoff pressure and/or shifting usable range/resolution may also be adjusted.

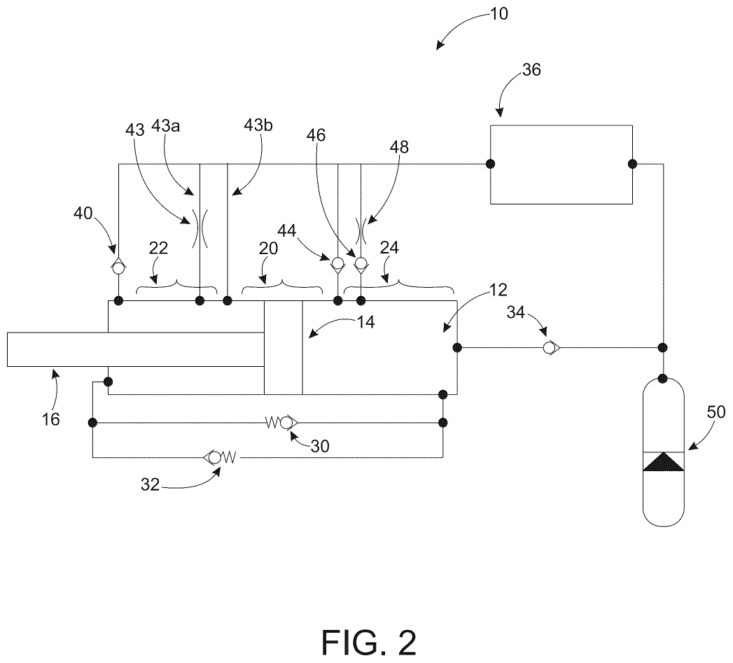

Referring to FIG. 2, a restriction or bleed 43 is provided with a bypass hole 43a in the TO zone 22. In between the TO zone 22 and the ride zone 20, a reflow hole 43b is provided adjacent the restriction or bleed 43. In this embodiment, the single valve shock 10 is optimized for adding stages to full TO zone forces. Adding small bleed holes (not shown) below reflow hole 43b allows for multiple TO zone stages. Using directional check valve 40 in TO zone 22 inhibits and/or prevents cavitation.

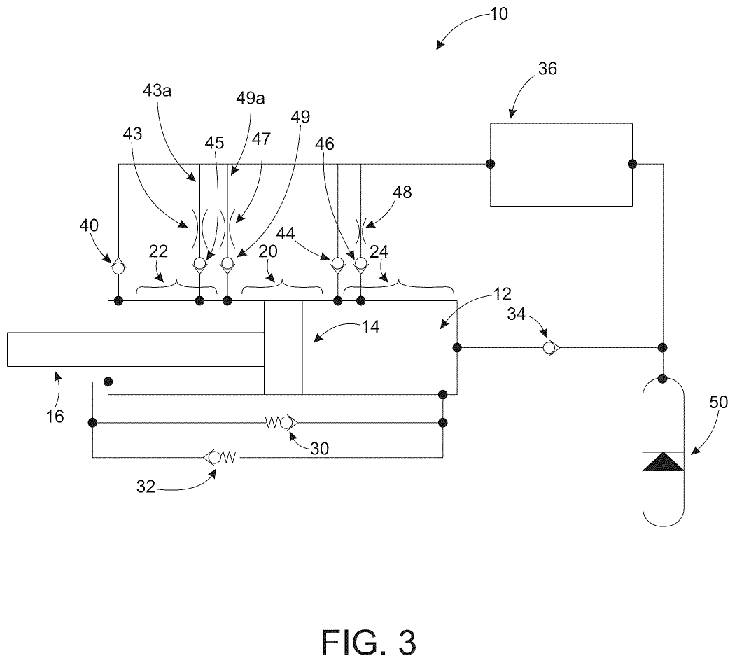

In FIG. 3, a check valve 45 is provided in the TO zone 22 with restriction or bleed 43 with bypass hole 43a. A restriction or bleed 47 and check valve 49 are provided with a bypass hole 49a. The restriction or bleed 47 and check valve 49 are provided between the TO zone 22 and the ride zone 20. In this embodiment, the single valve shock 10 is optimized for increasing high speed rebound damping in the ride zone (beyond blowoff of main piston), which may include omitting reflow holes and/or relying on high reflow through directional check valve 40. Embodiments may add check valves with TO zone bleeds.

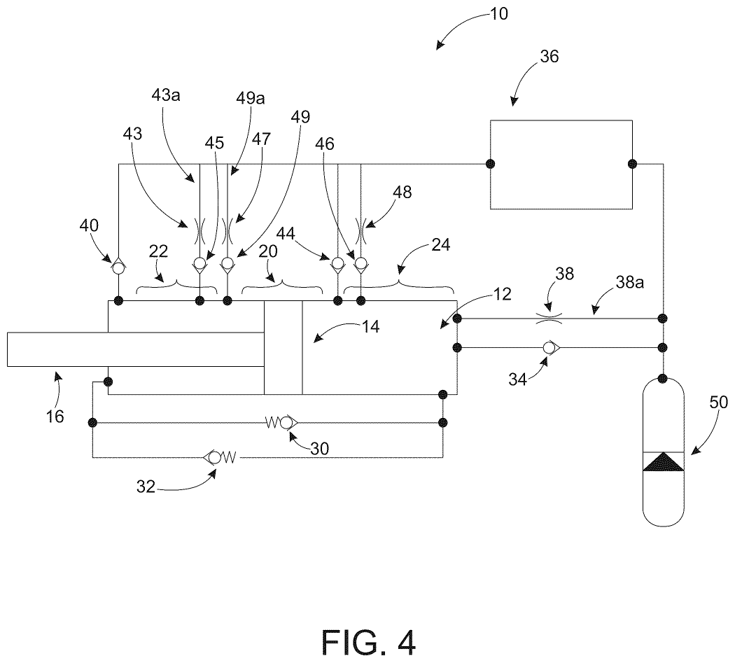

In FIG. 4, a refill restriction or bleed 38 is provided with bypass hole 38a parallel refill check valve 34 between the reservoir 50 and BO zone 24 of the inner body 12. Embodiments of the single valve shock 10 are optimized for decreasing compression damping through refill restriction or bleed 38. For example, the single valve shock 10 may include a bleed shim (not shown) as the refill check valve 34. This changes the compression characteristics versus rebound by enabling refill restriction or bleed 38 to bypass the single semi-active base valve 36 in the compression stroke, where it will not alter the rebound stroke.

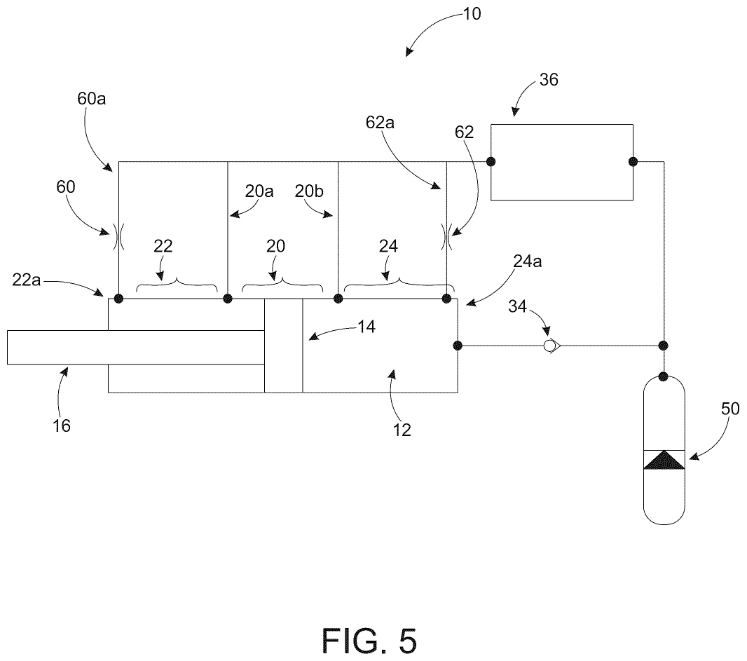

In FIG. 5, a restriction or bleed 60 is provided with bypass hole 60a in a bottom portion 22a of the TO zone 22. A restriction or bleed 62 is provided with bypass hole 62a in a top portion 24a of the BO zone 24. Embodiments of the single valve shock 10 may be optimized for cost using a solid main piston. The main piston compression valving may be omitted as well as the rebound valving resulting in a cost savings and requiring a modified flow architecture. The TO zone 22/BO zone 24 are defined by reflow holes 20a, 20b on opposite ends of the ride zone 20. Restricted flow paths are provided in the bottom portion 22a of TO zone 22 and the top portion 24a of BO zone 24.

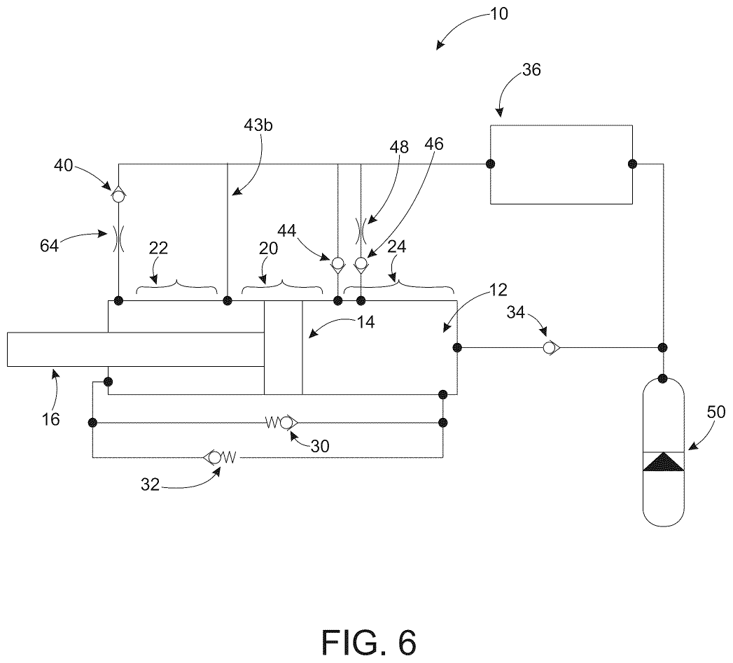

Referring to FIG. 6, a restriction or bleed 64 is provided in reflow before directional check valve 40 which communicates with the TO zone 22. The restriction or bleed 64 provided in the checked reflow of the directional check valve 40 adds restriction in compression stroke after top out to provide additional damping vs. free flow.

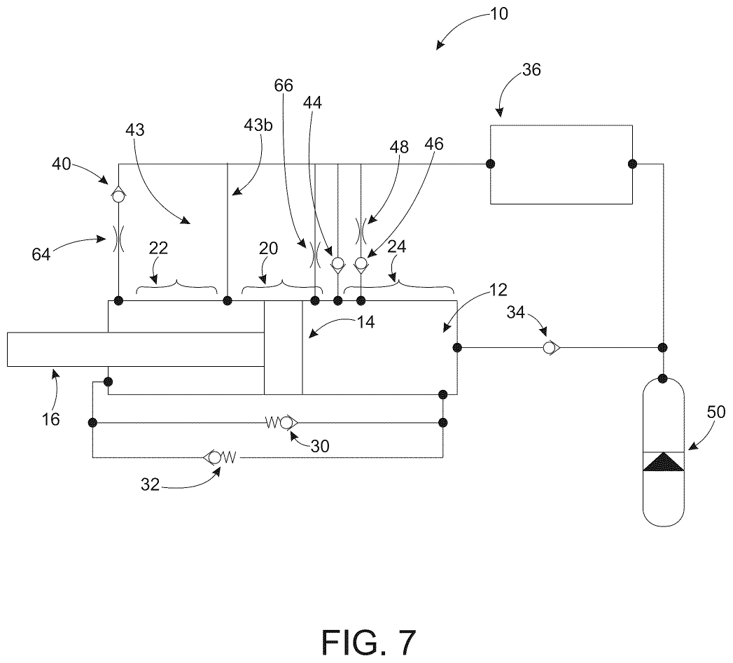

Referring to FIG. 7, a restriction or bleed 66 is provided on the inner body 12 within the ride zone 20. The restriction or bleed 66 provided on the inner body 12 softens the low speed rebound forces and creates a deep stroke rebound catch.

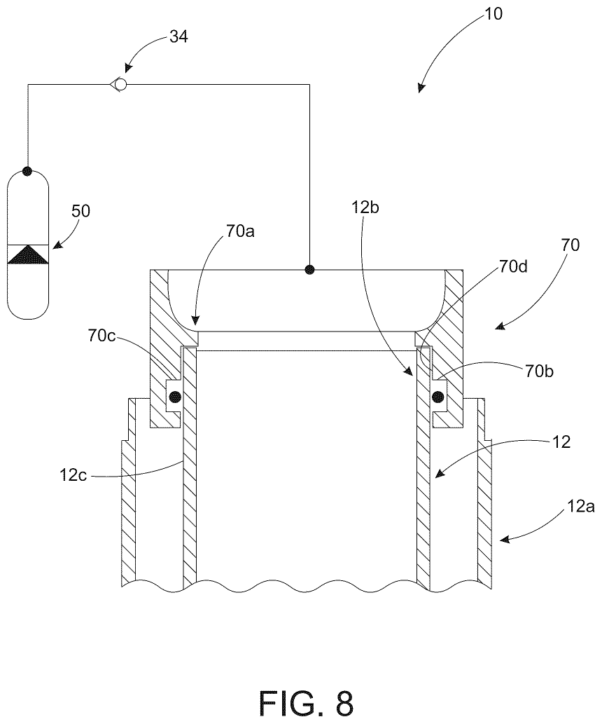

Referring to FIG. 8, a body adapter 70 is provided on an upper end portion 12b of the inner body 12 and within an outer body 12a. The body adapter 70 is fluidly connected to reservoir 50 via refill check valve 34. The body adapter 70 is provided with an inner annular flange portion 70a which is seated on upper end portion 12b of inner body 12. An O-ring 70b is provided within an annular channel 70c formed about an inner surface portion 70d of the body adapter 70. The O-ring 70b seals the body adapter 70 against an outer surface 12c of the inner body 12.

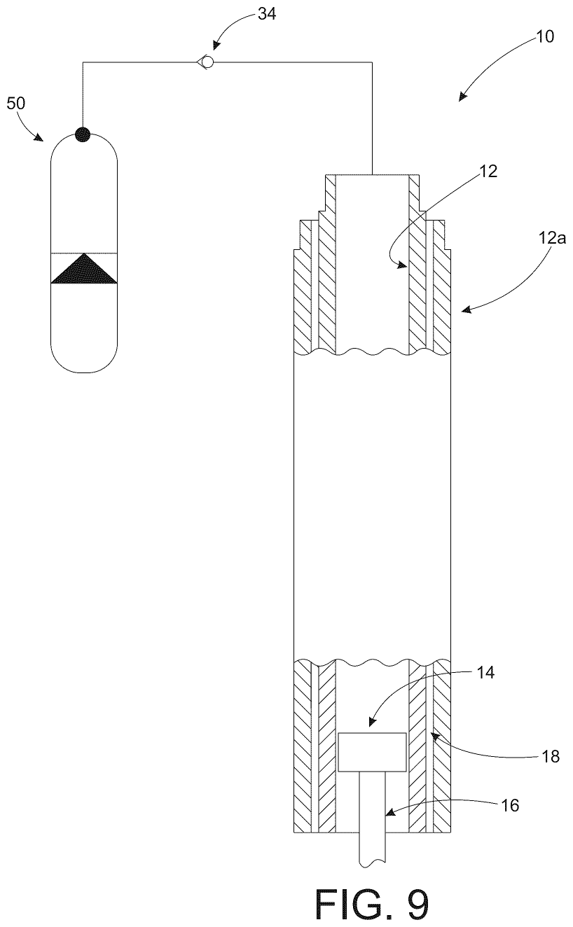

FIG. 9 shows the assembly of piston 14 and piston shaft 16 within inner body 12 and outer body 12a. The reservoir 50 is fluidly connected to the inner body 12 via refill check valve 34, as described above. The outer body 12a extends longitudinally along the length of the inner body 12 and provides an annular channel 18 therebetween. The piston 14 and piston shaft 16 are slidably received within the inner body 12. The outer body 12a is sleeved about the inner body 12.

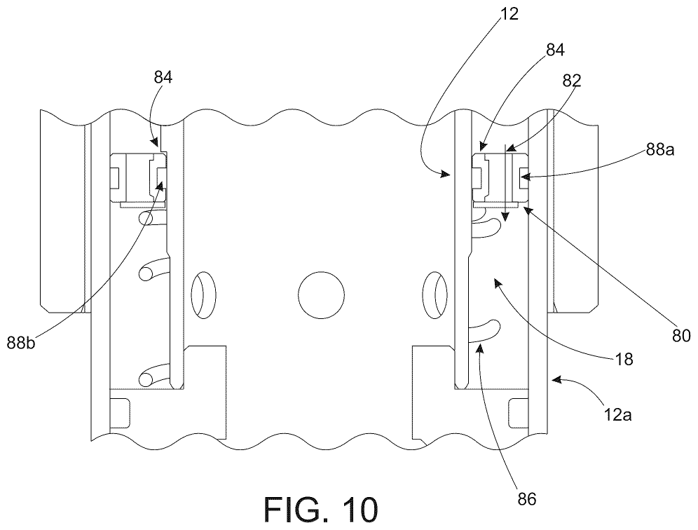

FIG. 10 shows a check valve annular assembly 82 between the inner body 12 and the outer body 12a within the annular channel 18. The check valve annular assembly 82 is retained by an upper shoulder stop 84 on the inner body 12 while being biased by a coil spring 86 forcing the check valve annular assembly 82 upwardly. O-rings 88a and 88b provide frictional force to the check valve annular assembly 82 to inhibit downward movement in addition to the coil spring 86 biasing upwardly.

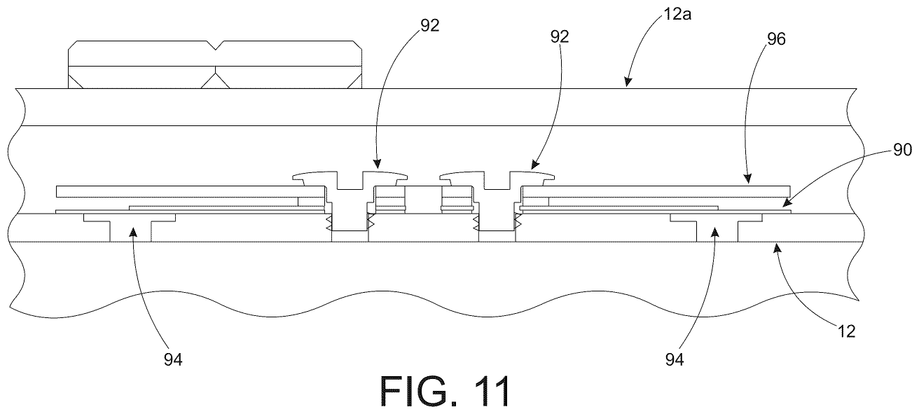

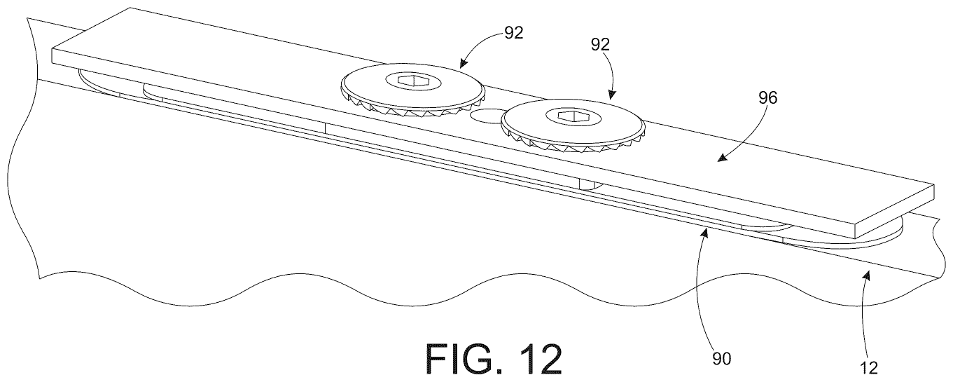

Referring to FIGS. 11 and 12, at least one bypass shim 90 is provided on the inner body 12 in order to open and close at least one aperture 94 provided in inner body 12. Backup plate 96 is provided over the at least one bypass shim 90 and is secured to the inner body 12 via securing bolts 92. The backup plate 96 inhibits outward movement of the at least one bypass shim 90 from the at least one aperture 94 provided in inner body 12. The backup plate 96 prevents the at least one bypass shim 94 from being overstressed by limiting outward deflection of the at least one bypass shim 90 toward the outer body 12a.

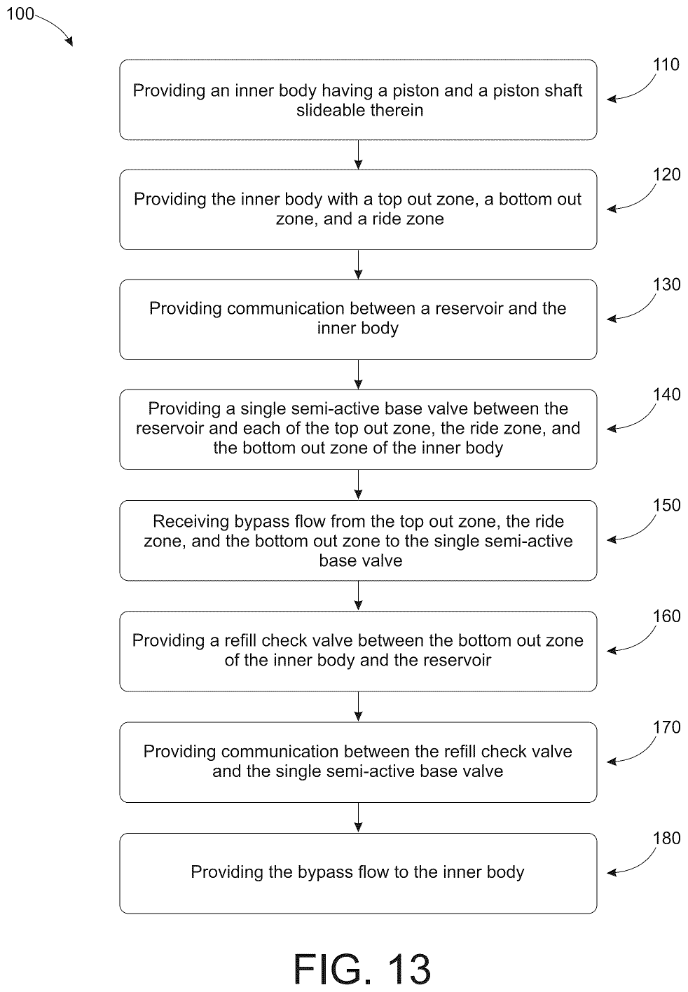

FIG. 13 is a block diagram of steps of a method of assembly of a single valve shock. Method 100 comprises: providing an inner body having a piston and a piston shaft slideable therein (Step 110); providing the inner body with a top out zone, a bottom out zone, and a ride zone (Step 120); providing communication between a reservoir and the inner body (Step 130); providing a single semi-active base valve between the reservoir and each of the top out zone, the ride zone, and the bottom out zone of the inner body (Step 140); receiving bypass flow from the top out zone, the ride zone, and the bottom out zone to the single semi-active base valve (Step 150); providing a refill check valve between the bottom out zone of the inner body and the reservoir (Step 160); providing communication between the refill check valve and the single semi-active base valve (Step 170); and providing the bypass flow to the inner body (Step 180).

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A single valve shock system comprising:
an inner body having a piston and a piston shaft slideable therein, wherein the inner body is provided with at least one zone;
a reservoir in communication with the inner body;
a single base valve provided between the reservoir and the at least one zone, wherein the single base valve receives bypass flow from the at least one zone; and
a refill check valve provided between the at least one zone of the inner body and the reservoir, wherein the refill check valve is in communication with the single base valve to provide the bypass flow to the inner body.

2. The system of claim 1, wherein the at least one zone comprises a top out zone, a bottom out zone and a ride zone.

3. The system of claim 1, wherein the single base valve is a single semi-active base valve.

4. The system of claim 3, wherein the refill check valve is provided between the bottom out zone of the inner body and the reservoir.

5. The system of claim 1, wherein a body adapter is provided on an upper end portion of the inner body.

6. The system of claim 5, wherein the body adapter is provided with an inner annular flange portion seated on the upper end portion.

7. The system of claim 6, wherein an O-ring is provided within an annular channel formed about an inner surface portion of the body adapter.

8. The system of claim 3, wherein a directional check valve is provided between the top out zone and the single semi-active base valve in order to accommodate the bypass flow.

9. The system of claim 2, further comprising a main piston compression valve and a main piston rebound valve provided between the top out zone and the bottom out zone.

10. The system of claim 2, wherein a check valve is provided between the top out zone and the ride zone.

11. The system of claim 2, wherein a bleed is provided in the top out zone and a reflow is provided between the top out zone and the ride zone.

12. The system of claim 2, wherein a first check valve and a first bleed are provided in the top out zone and a second check valve and a second bleed are provided between the top out zone and the ride zone.

13. The system of claim 2, wherein a bleed is provided between the bottom out zone and the reservoir parallel to the refill check valve.

14. The system of claim 2, wherein a first bleed is provided in a bottom portion of the top out zone and a second bleed is provided in a top portion of the bottom out zone.

15. The system of 14, wherein a first reflow is provided between the top out zone and the ride zone and a second reflow is provided between the ride zone and the bottom out zone.

16. A single valve shock system comprising:
an inner body having a piston and a piston shaft slideable therein, wherein the inner body is provided with at least one zone;
an outer body is provided about the inner body to provide an annular channel therebetween;
a reservoir in communication with the inner body;
a single base valve provided between the reservoir and the at least one zone, wherein the single base valve receives bypass flow from the at least one zone;
a refill check valve provided between the at least one zone of the inner body and the reservoir, wherein the refill check valve is in communication with the single base valve to provide the bypass flow to the inner body; and
a check valve annular assembly is provided on the inner body within the annular channel.

17. The system of claim 16, wherein the check valve annular assembly is seated against an upper shoulder stop provided on the inner body.

18. The system of claim 17, wherein a coil spring biases the check valve annular assembly against the upper shoulder stop.

19. A single valve shock system comprising:
an inner body having a piston and a piston shaft slideable therein, wherein the inner body is provided with at least one zone;
a reservoir in communication with the inner body;
a single base valve provided between the reservoir and the at least one zone, wherein the single base valve receives bypass flow from the at least one zone; and a refill check valve provided between the at least one zone of the inner body and the reservoir, wherein the refill check valve is in communication with the single base valve to provide the bypass flow to the inner body;
at least one bypass shim is provided along an outer surface of the inner body extending over at least one aperture provided in the inner body; and
a backup plate is provided over the at least one bypass shim.

20. A method of assembling a single valve shock comprising:
providing an inner body having a piston and a piston shaft slideable therein;
providing the inner body with a top out zone, a bottom out zone, and a ride zone;
providing communication between a reservoir and the inner body;
providing a single semi-active base valve between the reservoir and each of the top out zone, the ride zone, and the bottom out zone of the inner body;
receiving bypass flow from the top out zone, the ride zone, and the bottom out zone to the single semi-active base valve;
providing a refill check valve between the bottom out zone of the inner body and the reservoir;
providing communication between the refill check valve and the single semi-active base valve; and
providing the bypass flow to the inner body.
